(19) United States
(12) Patent Application Publication
(10) Pub. No.: US 2009/0162109 A1
(43) Pub. Date: Jun. 25, 2009

(54) CONDUCTIVE RUBBER ROLLER AND TRANSFER ROLLER

(75) Inventors: Naoki Koyama, Ushiku-shi (JP); Erika Umeki, Toride-shi (JP); Satoshi Fukuzawa, Ushiku-shi (JP)

Correspondence Address: FITZPATRICK CELLA HARPER & SCINTO, 30 ROCKEFELLER PLAZA, NEW YORK, NY, 10112, US

(73) Assignee: CANON KASEI KABUSHIKI KAISHA, Tokyo (JP)

(21) Appl. No.: 12/326,667

(22) Filed: Dec. 2, 2008

(30) Foreign Application Priority Data
Dec. 21, 2007 (JP) 2007-330089

(51) Int. Cl. G03G 15/08

(52) U.S. Cl. 399/286

(57) ABSTRACT

A conductive rubber roller and transfer roller whose resistance value is easily controlled and which lowers contamination of a charged member and has excellent electric variability and compressive permanent set is provided at low cost. There is provided a conductive rubber roller for use in an electrophotographic process, wherein a rubber component of the conductive rubber roller has at least acrylonitrile butadiene rubber whose acrylonitrile content is 15% by mass to 25% by mass (both inclusive) and weight average molecular weight (Mw) is 500,000 to 1,000,000 (both inclusive), and epichlorohydrin type rubber whose ethylene oxide content is not less than 70% by mole to less than 90% by mole; and the acrylonitrile butadiene rubber is contained in an amount of 5 parts by mass to 80 parts by mass (both inclusive) in 100 parts by mass of the rubber component.

### BACKGROUND OF THE INVENTION

1. Field of the Invention

The present invention relates to a conductive rubber roller for use in image-forming apparatuses such as electrophotographic copying machines, printers and electrostatic recording apparatuses. More specifically, the present invention relates to a transfer roller of a transfer apparatus for transferring a transferable image of toner, which is formed in an image-forming process such as an electrophotographic process or an electrostatic recording process and carried by an image bearing member such as an electrophotographic photosensitive member, onto a recording medium such as paper and a transfer material.

2. Description of the Related Art

In various types of electrographic apparatuses such as electrostatic copying machines, laser printers and facsimiles, various types of conductive rubber parts including a conductive roller are employed. As the material for conductive rubber parts, a material having an appropriate elasticity and having a volume resistivity value within a medium resistance region from 10⁵ Ω·cm or more and 10¹⁰ Ω·cm or less and a stable resistance value (a resistance value does not widely vary and variation of resistance value is low by application of voltage) is used. Of them, epichlorohydrin rubber and acrylonitrile butadiene rubber are widely used (for example, see Japanese Patent Application Laid-Open No. 2002-287456).

Recently, to respond formation of a colored/high quality image at a high speed, a conductive rubber roller has been desired to be further reduced in resistance and hardness and has excellent durability. In the circumstances, to reduce hardness, use of a low-viscosity material has been proposed. Furthermore, to reduce the volume resistivity value, use of epichlorohydrin type rubber containing a large amount of ethylene oxide and addition of an ion conductive agent have been proposed (for example, see Japanese Patent Application Laid-Open No. 2006-235519). However, a conductive rubber roller using such a rubber elastic material has the following problems in general:
Since the resistance value varies with an environmental change such as temperature and humidity, image quality varies with the operating environment.
When an ion conductive agent is added to reduce the resistance value, the agent causes bleeding on the surface of a member and contaminates a photosensitive member.

As described above, in a conventional conductive rubber roller, the volume resistivity value thereof is controlled by blending epichlorohydrin type rubber having a low volume resistivity value or an ion conductive agent with acrylonitrile butadiene rubber. However, the properties of the conductive rubber roller are determined by a blending ratio of acrylonitrile to epichlorohydrin type rubber. To further reduce resistance, acrylonitrile rubber containing a large amount of acrylonitrile is used. However, a resistance value becomes worse due to an environmental change and hardness increases. Alternatively, there is a method of using a larger amount of epichlorohydrin type rubber. However, in this method, material cost increases.

### SUMMARY OF THE INVENTION

An object of the present invention is to solve the aforementioned problems and to provide a conductive rubber roller and transfer roller whose resistance value is easily controlled and which lowers contamination of a charged member and has excellent electric variability and compressive permanent set, at low cost.

According to the present invention, there is provided a conductive rubber roller for use in an electrophotographic process, wherein a rubber component of the conductive rubber roller has at least acrylonitrile butadiene rubber whose acrylonitrile content is 15% by mass or more and 25% by mass or less and weight average molecular weight (Mw) is 500,000 or more and 1,000,000 or less, and epichlorohydrin type rubber whose ethylene oxide content is 70% by mole or more and less than 90% by mole; and the acrylonitrile butadiene rubber is contained in an amount of 5 parts by mass or more and 80 parts by mass or less in 100 parts by mass of the rubber component.

According to the present invention, there is also provided a transfer roller for use in a transfer apparatus for an electrophotographic process using the aforementioned conductive rubber roller. As described above, the present invention enables to provide a conductive rubber roller and transfer roller whose resistance value is easily controlled, and which has no clinging to a charged member and has excellent electric variability and compressive permanent set, at low cost.

Further features of the present invention will become apparent from the following description of exemplary embodiments with reference to the attached drawings.

### BRIEF DESCRIPTION OF THE DRAWINGS

FIG. 1 is a view illustrating a schematic structure of conductive rubber roller of the present invention.

FIG. 2 is a sectional view of an entire image-forming apparatus according to the present invention.

FIG. 3 is an apparatus for manufacturing a conductive rubber roller of the present invention by continuous vulcanization using a microwave.

### DESCRIPTION OF THE EMBODIMENTS

Preferred embodiments of the present invention will now be described in detail in accordance with the accompanying drawings.

In the conductive rubber roller of the present invention, a rubber component has at least acrylonitrile butadiene rubber whose acrylonitrile content is 15% by mass or more and 25% by mass or less and weight average molecular weight (Mw) is 500,000 or more and 1,000,000 or less, epichlorohydrin type rubber whose ethylene oxide content is 70% by mole or more and less than 90% by mole; and the acrylonitrile butadiene rubber is contained in an amount of 5 parts by mass or more and 80 parts by mass or less in 100 parts by mass of the rubber component.

When the acrylonitrile content of the acrylonitrile butadiene rubber is less than 15% by mass, the volume resistivity value is high. When the content exceeds 25% by mass, the resistivity value greatly varies depending upon the environment. On the other hand, when the weight average molecular weight (Mw) is less than 500,000, inter-locking between molecules is reduced and the volume resistivity value increases. In contrast, when the weight average molecular weight (Mw) is 500,000 or more, the volume resistivity value decreases. In the present invention, it was found that the weight average molecular weight (Mw) of the acrylonitrile butadiene rubber has a large effect upon electric properties. As the weight average molecular weight (Mw) of acrylonitrile butadiene rubber increases, the degree of inter-locking between molecules increases and coordination/transfer efficiency of hydronium ions improves, improving ion conductivity. As a result, the volume resistivity value decreases. In addition, degree of co-crosslinking with the epichlorohydrin type rubber improves, improving ion conductivity. However, when the weight average molecular weight exceeds 1,000,000, the rubber becomes extremely hard and processability thereof decreases. In addition, molecular mobility decreases and volume resistivity value increases. As described above, the weight average molecular weight of the acrylonitrile butadiene rubber is 500,000 or more and 1,000,000 or less and preferably 700,000 or more and 1,000,000 or less.

In the present invention, the weight average molecular weight of acrylonitrile butadiene rubber is measured by GPC (gel permeation chromatography) in accordance with the customary method as follows.

More specifically, a measuring resin was placed in tetrahydrofuran. After allowed to stand still for several hours, the measuring resin was mixed well with tetrahydrofuran while shaking (until a mass of measuring resin disappeared) and allowed to stand still for further 12 hours or more.

Thereafter, the mixture was passed through a sample treatment filter, My Shori-disk H-25-5, manufactured by Tosoh Corporation to prepare a GPC sample.

Next, a column was stabilized in a heat chamber of 40° C. To the column maintained at this temperature, tetrahydrofuran was supplied as a solvent at a flow rate of 0.5 ml/minute and 100 μl of the GPC sample was injected to measure the weight average molecular weight of the measuring resin. Two Shodex KF-805L columns were connected and used herein.

When the weight average molecular weight of the measuring resin was measured, the molecular weight distribution of the measuring resin was calculated based on the relationship between the log value and the count number of a calibration curve obtained from several types of monodisperse polystyrene standard samples. As the polystyrene standard samples for forming the calibration curve, monodisperse polystyrene manufactured by POLYMER LABORATORIES was used. As the monodisperse polystyrene, 10 samples having molecular weights of 580, 2,930, 9,920, 28,500, 59,500, 148,000, 320,000, 841,700, 2,560,000, and 7,500,000 were used. As the detector, an RI (Refractive Index) detector was used.

Also, when the ethylene oxide content of the epichlorohydrin type rubber is less than 70% by mole, the volume resistivity value increases. Therefore, to obtain a predetermined resistance value, epichlorohydrin type rubber expensive in unit cost must be contained in a large amount. The raw material cost increases. When the content exceeds 90% by mole, crystallinity inhibiting electric conductivity increases and volume resistivity value also increases.

Furthermore, when the content of acrylonitrile butadiene rubber having a weight average molecular weight (Mw) of 500,000 or more and 1,000,000 or less is less than 5 parts by mass in 100 parts by mass of the rubber component, inter-locking of molecules produces no effect and the volume resistivity value does not decrease. Furthermore, when the content of acrylonitrile butadiene rubber exceeds 80 parts by mass, the effect of the molecular weight is reduced. Therefore, the content is 5 parts by mass or more and 80 parts by mass or less, and preferably 10 parts by mass or more and 60 parts by mass or less.

Examples of the epichlorohydrin type rubber may include an epichlorohydrin homopolymer, an epichlorohydrin/ethylene oxide binary copolymer and a ternary copolymer of epichlorohydrin/ethylene oxide/allyl glycidyl ether. Of them, the ternary copolymer of epichlorohydrin/ethylene oxide/allyl glycidyl ether is preferable in view of electro conductivity and bleed suppression. An epichlorohydrin/ethylene oxide copolymer is crosslinked with allyl glycidyl ether to properly form a three-dimensional structure, thereby suppressing bleed. Since ethylene oxide is copolymerized, volume resistivity value is reduced.

The variation in resistance value of the acrylonitrile butadiene rubber depending upon the environment is smaller than that of the ternary copolymer of epichlorohydrin type rubber-epichlorohydrin/ethylene oxide/allyl glycidyl ether and unit cost of a raw material is low. Therefore, the variation in resistance value can be improved and raw material cost can be suppressed.

The conductive rubber roller of the present invention is produced by vulcanization and foaming by a microwave generator (UHF). Provided that the resistance value of the roller under a 23° C./55% RH environment is expressed by R[Ω], log R is preferred to be 5.8 or more and 8.3 or less. When the logarithmic value (log R) of resistance value of the roller is less than 5.8, variation of resistance depending upon the environment becomes excessively large. As a result, it becomes difficult to control transferability. On the other hand, when the logarithmic value (log R) exceeds 8.3, toner cannot be uniformly transferred. As a result, it is likely to form a defective image.

In the conductive rubber roller of the present invention, a filler is used other than a rubber component. As the filler, other components used in general rubber may be contained as needed. Examples of other components that may be blended as needed include: a vulcanizing agent such as sulfur or an organic sulfur-containing compound, a vulcanization accelerator, a foaming agent, a processing aid such as a lubricant or factice, an antiaging agents, a vulcanization auxiliary such as zinc oxide or stearic acid, and a bulking agent such as calcium carbonate, talc, silica, clay or carbon black.

A rubber composition for use in the conductive rubber roller is kneaded by use of an open roll or an airtight kneader, etc., and molded by use of an extruder.

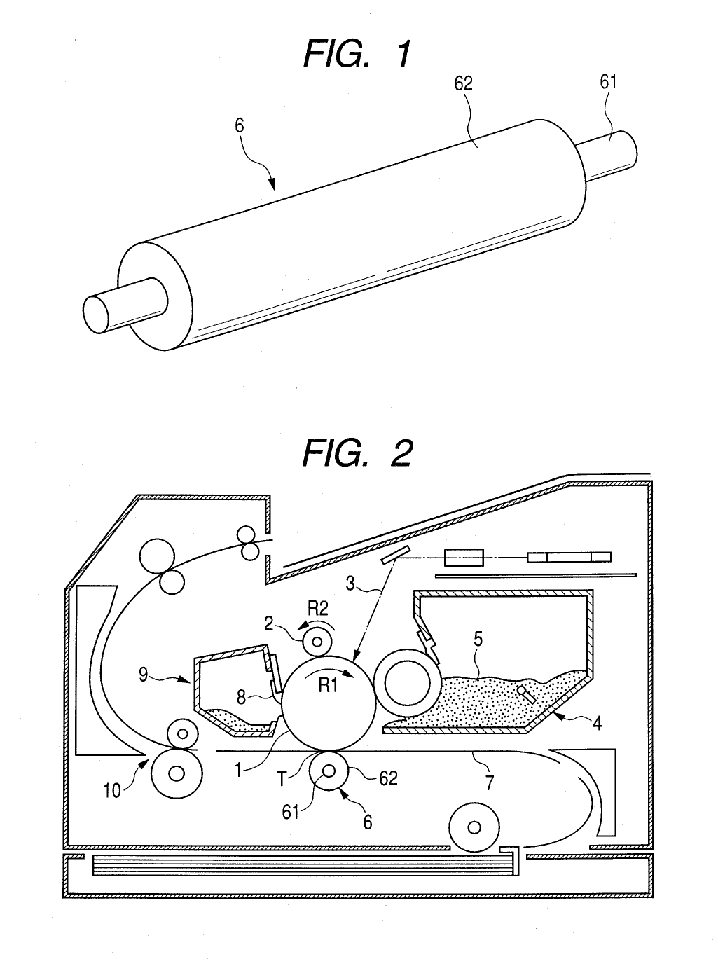

A method of manufacturing a conductive rubber roller will be described referring to FIG. 1. A rubber composition of the conductive rubber roller 6 of the present invention is extruded by an extruder in the form of tube and heated by a microwave vulcanization device (UHF) to form a conductive rubber tube (elastic body). Thereafter, a conductive shaft 61 is inserted and the tube is polished until a predetermined outer diameter is obtained. The conductive rubber roller 6 of the present invention may be a layered structure, as needed, having two or more layers by providing a layer formed of a rubber or a resin, etc., onto the outer periphery of a vulcanized and foamed rubber layer 62.

Next, an example of an image-forming apparatus employing a transfer roller, according to the present invention will be described referring to the accompanying drawing.

(Image-Forming Apparatus)

The image-forming apparatus shown in FIG. 2 is a laser printer using an electrophotographic process cartridge. The drawing is a longitudinal sectional view showing a schematic structure of the apparatus. Furthermore, the image-forming apparatus shown in the drawing is equipped with a transfer unit having the transfer roller.

The image-forming apparatus shown in this drawing has an electrophotographic photosensitive member 1 in the form of drum (hereinafter referred to as a “photosensitive drum”) as an image bearing member. The photosensitive drum 1 has a photosensitive layer formed of an organic photoconductor (OPC) provided on the outer periphery of a cylindrical aluminum base, which is grounded. The photosensitive drum 1 is rotated and driven by a driving unit (not shown) at a predetermined process speed (circumferential speed), for example, 50 mm/sec, in the direction indicated by arrow R1.

The surface of the photosensitive drum 1 is uniformly charged by a charge roller 2 as a contact charging member. The charge roller 2 is arranged in contact with the surface of the photosensitive drum 1 and rotated and driven in the direction indicated by arrow R2 in accordance with the rotation of the photosensitive drum 1 in the direction indicated by arrow R1. To the charge roller 2, oscillation voltage (alternating-current voltage VAC+direct-current voltage VDC) is applied by a charge bias application power supply (high voltage power supply). In this way, the surface of the photosensitive drum 1 is uniformly charged to −600 V (dark-space voltage, Vd). To the surface of the photosensitive drum 1 charged, laser light 3, which is emitted from a laser scanner and reflected by a mirror, more specifically, laser light modified so as to correspond to a time-series electro-digital signal of desired image information, is exposed in a scanning manner. In this way, an electrostatic latent image (light space voltage V1=−150 V) corresponding to the desired image information is formed on the surface of the photosensitive drum 1.

The electrostatic latent image is reversibly developed as a toner image by depositing toner negatively charged by a developing bias applied to a developing sleeve of a developing apparatus 4.

On the other hand, a transfer material 7 such as paper fed from a paper feeder (not shown) is guided by a transfer guide and supplied to a transfer portion (transfer nip portion) T between the photosensitive drum 1 and the transfer roller 6 in synchronism with the supply of a toner image on the photosensitive drum 1. Onto the transfer material 7 supplied to the transfer portion T, the toner image on the photosensitive drum 1 is transferred by a transfer bias applied to the transfer roller 6 by a transfer bias application power supply. At this time, the toner (residual toner) remaining on the surface of the photosensitive drum 1 without being transferred to the transfer material 7 is removed by a cleaning blade 8 of a cleaning apparatus 9.

The transfer material 7 passed through the transfer portion T is separated from the photosensitive drum 1 and introduced into a fixation apparatus 10. The toner image is fixed therein and discharged from the image-forming apparatus main body (not shown) as a material (printed matter) having an image formed thereon.

Next, the conductive rubber roller of the present invention was manufactured as follows.

(Manufacturing Method)

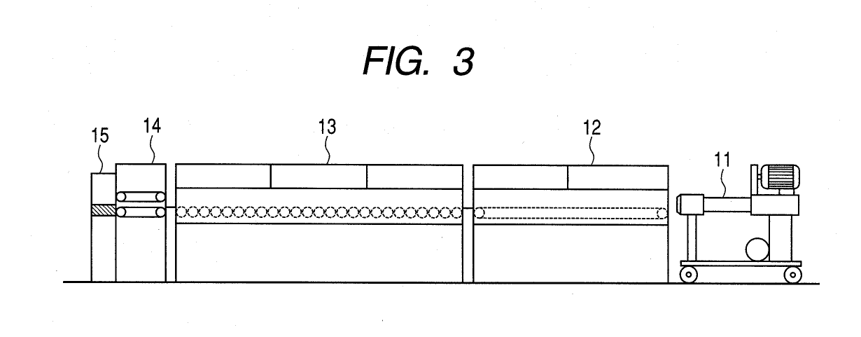

FIG. 3 shows an apparatus for manufacturing a conductive rubber roll by continuous vulcanization using a microwave. An extrusion vulcanization apparatus used in the present invention has a total length of 13 m and has an extruder 11, a microwave vulcanization unit (UHF) 12, a hot-air vulcanization unit 13 (hereinafter, referred to as a “HAV”), a winder 14 and a cutter 15.

A rubber composition according to the conductive rubber roller of the present invention is kneaded using Banbury mixer or an airtight kneader such as a kneader. Thereafter, a vulcanizing agent and a foaming agent are added to the kneaded material by an open roll and the mixture is molded in the form of ribbon by a ribbon-form molding machine and loaded into the extruder 11. In the UHF 12, the rubber tube extruded from the extruder 11 is conveyed by a mesh-belt coated with PTFE (polytetrafluoroethylene) resin or rods coated with PTFE (polytetrafluoroethylene) resin. In the HAV 13, transfer is performed by rods coated with PTFE resin. The UHF 12 and the HAV 13 are connected with a rod coated with PTFE resin.

The lengths of the units 12, 13 and 14 are as shown in the drawing. In this embodiment, the length of the units 12, 13 and 14 are 4 m, 6 m and 1 m, respectively. The space between the UHF 12 and the HAV 13 and the space between the HAV 13 and the winder 14 are set to be 0.1 to 1.0 m.

In the manufacturing apparatus by continuous vulcanization using a microwave, immediately after the rubber tube is molded into the form of tube and extruded by the extruder 11, the tube is conveyed into the UHF 12 whose atmosphere is set at a temperature of 220° C. Thereafter, a microwave is applied to the rubber tube to heat the rubber tube, thereby performing vulcanization and foaming. Subsequently, the tube is transferred to the HAV 13 to complete vulcanization.

In the vulcanization/foaming step mentioned above, the microwave applied in the microwave vulcanization furnace of the UHF 12 preferably has 2450 150 MHz. The rubber tube can be uniformly and efficiently irradiated by a microwave having a frequency within the range. The temperature of the hot air within the UHF furnace is preferably 150° C. or higher and 250° C. or lower and particularly preferably 180° C. or higher and 230° C. or lower.

After vulcanized and foamed, the rubber tube is discharged by the winder 14. Immediately after the discharge, the rubber tube is cut into pieces of predetermined desired sizes by the cutter 15 to form tube-form conductive rubber molded products. Subsequently, a conductive shaft of φ4 mm or more and 10 mm or less is inserted by application of pressure into the inner core portion of the tube-form conductive rubber molded product to obtain a roller-form molded product.

### EXAMPLES

The present invention will be more specifically described below by way of Examples and Comparative Examples; however, the present invention is not limited to these.

The rubber materials used in Examples and Comparative Examples are as follows. Note that the unit of blending quantities is parts by mass.

### Acrylonitrile Butadiene Rubber

(1) Trade name: NipolDN401LL [the content of acrylonitrile associated: 18% by mass, weight average molecular weight: 470,000], manufactured by Zeon Corporation

(2) Trade name: NipolDN401L [the content of acrylonitrile associated: 18% by mass, weight average molecular weight: 700,000] manufactured by Zeon Corporation

(3) Trade name: NipolDN401 [the content of acrylonitrile associated: 18% by mass, weight average molecular weight: 780,000] manufactured by Zeon Corporation

(4) Trade name: N230SV [the content of acrylonitrile associated: 35% by mass] manufactured by JSR Corporation

### A Ternary Copolymer of Epichlorohydrin/Ethylene Oxide/Allyl Glycidyl Ether (GECO)

Trade name: EPION301 [the content of ethylene oxide: 73% by mole] manufactured by Zeon Corporation

Trade name: HydrinT3106S [the content of ethylene oxide: 56% by mole] manufactured by Daiso Co., Ltd.

### Vulcanizing Agent

Sulfur (S), trade name: SALFAX PMC manufactured by Tsurumi Chemical Industry Co., Ltd.

### Vulcanizing Accelerator

Dibenzothiazyl disulfide (DM), trade name: NOCCELER DM, manufactured by Ouchi Shinko Chemical Industrial Co. Ltd.

Tetraethylthiuram disulfide (TET); trade name: NOCCELER TET, manufactured by Ouchi Shinko Chemical Industrial Co., Ltd.

### Vulcanizing Accelerator Auxiliary

Zinc Oxide; trade name: zinc flower (2 types), manufactured by Hakusuitech Ltd.

### Auxiliary

Stearic acid, trade name: Lunak S20 manufactured by Kao Corporation

### Filler

Carbon black, trade name: Asahi#35 manufactured by Asahi Carbon Co., Ltd.

### Foaming Agent

p.p′-oxybissulfonyl hydrazide (OBSH), trade name: NEOCELLBORN N1000#S manufactured by Eiwa Chemical Ind. Co., Ltd.

Note that the conductive rubber members of Examples and Comparative Examples were manufactured in accordance with the formulation shown in Table 1 by the aforementioned manufacturing apparatus, more specifically, manufactured through vulcanization and foaming performed by a microwave vulcanization furnace (UHF) (in which a microwave of 2450 MHz was applied) followed by a hot air furnace under the conditions such that the hardness of the resultant tube-form vulcanized rubber product became 200 to 500 (both inclusive). Subsequently, the conductive shaft of φ6 mm was inserted in the core portion of the tube-form vulcanized rubber product to obtain a roller-form product. The formed product was polished so as to obtain an outer diameter of φ16 mm.

(Clinging Test to Charged Member)

The roller was used as a transfer roller and brought into contact with an electrophotographic photosensitive member of the cartridge to be used in a laser printer, Laser Jet 4000N manufactured by Hewlett-Packard Development Company, L.P. Then, a weight of 4.9 N was applied to both sides of the shaft and the roller was allowed to stand for a week in a 40° C./95% RH environment. Thereafter, weight was removed and whether the roller clung to the electrophotographic photosensitive member or not was observed. The roller did not cling to the electrophotographic photosensitive member was indicated by A, whereas the roller clung to the electrophotographic photosensitive member even slightly was indicated by C.

(Method for Measuring Electric Resistance of Roller and the Amount Varied with Environmental Change)

The roller was placed in a normal temperature/normal humidity (23° C./55% RH) environment and 4.9 N weight was applied to both sides of the shaft of the conductive roller and brought into pressure contact with an aluminum drum having an outer diameter of 30 mm. Then, the roller resistance was measured while rotating the roller at a circumference speed of 50 mm/sec. At this time, 2 kV of voltage was applied between the shaft and the aluminum drum. The roller resistance (T1) at a low-temperature/low humidity environment (15° C./10% RH) and the roller resistance (T2) at a high temperature/high humidity environment (32.5° C./80% RH) were obtained. The range of the roller resistance varied with an environmental change was regarded as the difference between T1 value and T2 value in terms of logarithm and calculated in accordance with the equation: log 10 (T1)−log 10 (T2).

(Test for Compressive Permanent Set)

Strain amount was measured by compressing the roller at 70° C. for 24 hours in accordance with JIS K-6262.

(Evaluation)

The roller having a satisfactory balance between the variation of resistance with an environmental change and compressive permanent set and exhibiting no cling to a charged member was indicated by A and others were indicated by C.

TABLE 1

| | Example | | | | | | | Comparative Example | | | | |
|---|---|---|---|---|---|---|---|---|---|---|---|---|
| | 1 | 2 | 3 | 4 | 5 | 6 | 7 | 1 | 2 | 3 | 4 | 5 |
| Acrylonitrile butadiene rubber 1 | | | 40 | 75 | | 60 | 30 | | 80 | | 76 | |
| (AN amount: 18% by mass, | | | | | | | | | | | | |
| Mw: 470,000) | | | | | | | | | | | | |
| Acrylonitrile butadiene rubber 2 | 80 | 60 | 40 | 5 | 60 | | 40 | | | 75 | 4 | 85 |
| (AN amount: 18% by mass, | | | | | | | | | | | | |
| Mw: 700,000) | | | | | | | | | | | | |
| Acrylonitrile butadiene rubber 3 | | | | | 20 | 20 | 10 | | | | | |
| (AN amount: 18% by mass, Mw: | | | | | | | | | | | | |
| 760,000) | | | | | | | | | | | | |
| Acrylonitrile butadiene rubber | | | | | | | | 80 | | | | |
| (AN amount: 35% by mass) | | | | | | | | | | | | |
| Epichlorohydrin type rubber (GECO) | 20 | 40 | 20 | 20 | 20 | 20 | 20 | 20 | 20 | | 20 | 15 |
| (EO amount: 73% by mole) | | | | | | | | | | | | |
| Epichlorohydrin type rubber (GECO) | | | | | | | | | | 25 | | |
| (EO amount: 56% by mole) | | | | | | | | | | | | |
| Zinc oxide | 5 | | | | | | | 5 | | | | |
| Stearic acid | 1 | | | | | | | 1 | | | | |
| Carbon black | 30 | | | | | | | 30 | | | | |
| Sulfur | 1.5 | | | | | | | 1.5 | | | | |
| DM | 2 | | | | | | | 2 | | | | |
| TET | 1 | | | | | | | 1 | | | | |
| OBSH | 6 | | | | | | | 6 | | | | |
| Clinging to charged member | A | A | A | A | A | A | A | C | C | A | C | Processability C |
| Roller resistance (log R) (Ω) | 7.70 | 7.00 | 7.90 | 8.05 | 7.60 | 7.90 | 7.85 | 7.80 | 8.10 | 7.70 | 8.10 | |
| Amount varied with environmental | 1.1 | 1.3 | 1.15 | 1.15 | 1.2 | 1.15 | 1.15 | 1.3 | 1.2 | 1.3 | 1.2 | |
| change | | | | | | | | | | | | |
| Compressive permanent set (%) | 11 | 16 | 13 | 15 | 10 | 13 | 12 | 17 | 16 | 15 | 16 | |
| Evaluation | A | A | A | A | A | A | A | C | C | C | C | C |

Comparative Examples 1 and 2 are examples of rubber rollers containing no acrylonitrile butadiene rubber whose acrylonitrile content is 15% by mass or more and 25% by mass or less and weight average molecular weight (Mw) is 500,000 or more and 1,000,000 or less. Even if the same amounts of acrylonitrile butadiene rubber and epichlorohydrin type rubber as those of Example 1 are contained, the degree of inter-locking of molecules is low. Therefore, the resistance value increases, the roll clings, and the variation of resistance with an environmental change and compressive permanent set decrease.

Comparative Example 3 is an example of a rubber roller using an epichlorohydrin type rubber whose ethylene oxide content is outside the range of 70% by mole or more and less than 90% by mole. Compared to Example 1, a large amount of epichlorohydrin type rubber must be added to obtain the same resistance value. As a result, the variation of resistance with an environmental change and compressive permanent set decrease. In addition, since a large amount of epichlorohydrin type rubber is contained, material cost increases.

Comparative Examples 4 and 5 are examples of rubber rollers containing acrylonitrile butadiene rubber whose acrylonitrile content is 15% by mass or more and 25% by mass or less and weight average molecular weight (Mw) is 500,000 or more and 1,000,000 or less in an amount outside the range of 5 parts by mass or more and 80 parts by mass or less based on the 100 parts by mass of rubber component. When Comparative Example 4 is compared to Example 4, the resistance value is high, the roll clings, and the variation of resistance with an environmental change and compressive permanent set decrease. Furthermore, even if compared to Comparative Example 2, only the same properties are obtained. In Comparative Example 5, the processability decreases and thus a roller-form product was not obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-330089, filed Dec. 21, 2007, which is hereby incorporated by reference herein in its entirety.

What is claimed is:

1. A conductive rubber roller for use in an electrophotographic process, wherein
a rubber component of the conductive rubber roller has at least
acrylonitrile butadiene rubber whose acrylonitrile content is 15% by mass or more and 25% by mass or less and weight average molecular weight (Mw) is 500,000 or more and 1,000,000 or less, and
epichlorohydrin type rubber whose ethylene oxide content is 70% by mole or more and less than 90% by mole; and
the acrylonitrile butadiene rubber is contained in an amount of 5 parts by mass or more and 80 parts by mass or less in 100 parts by mass of the rubber component.

2. The conductive rubber roller according to claim 1, wherein the epichlorohydrin type rubber is a ternary copolymer of epichlorohydrin/ethylene oxide/allyl glycidyl ether.

3. The conductive rubber roller according to claim 1, wherein the conductive rubber roller is formed by vulcanization and foaming in a microwave generator (UHF) and has a log R of 5.8 or more and 8.3 or less, provided that R is a roller resistance value (Ω) under a 23° C./55% RH environment.

4. A transfer roller for use in a transfer apparatus used in an electrophotographic process using the conductive rubber roller according to claim 1.
